(19) United States
(12) Patent Application Publication
(10) Pub. No.: US 2018/0090878 A1
(43) Pub. Date: Mar. 29, 2018

(54) MAGNETIC RF CONNECTORS

(71) Applicant: Apple Inc., Cupertino, CA (US)

(72) Inventors: Brian C. Joseph, San Jose, CA (US); Cindy Wang, San Jose, CA (US); John Cirlia, Cupertino, CA (US)

(73) Assignee: Apple Inc., Cupertino, CA (US)

(21) Appl. No.: 15/713,700

(22) Filed: Sep. 25, 2017

Related U.S. Application Data
(60) Provisional application No. 62/399,303, filed on Sep. 23, 2016.

(51) Int. Cl. H01R 13/62; H01R 24/40; H01R 11/30; H01P 5/02

(52) U.S. Cl. CPC H01R 13/6205; H01R 24/40; H01R 13/6277; H01P 5/026; H01R 11/30

(57) ABSTRACT

Connector systems that may be easy to use, may be used to make connections in a limited area, may provide a stable and consistent connection, may provide good impedance matching, and may provide a good user experience. Various embodiments of the present invention may provide connector systems for conveying radio frequency (RF) signals.

### CROSS-REFERENCES TO RELATED APPLICATIONS

This application claims the benefit of U.S. provisional patent application No. 62/399,303, filed Sep. 23, 2016, which is incorporated by reference.

### BACKGROUND

Power and data may be provided from one electronic device to another over cables that may include one or more wires, fiber optic cables, or other conductors. Connector inserts may be located at each end of these cables and may be inserted into connector receptacles in the communicating or power transferring electronic devices.

In some systems, these cables may convey very high-speed signals. To achieve these high speeds, they may include various interlocking features to keep a connector insert and a connector receptacle mated in a secure and consistent manner. But these features may make the connectors difficult to use. Accordingly, it may be desirable to provide connector inserts and connector receptacles that do not rely on these interlocking features to provide a secure and consistent connection.

Moreover, these connector receptacles may be located on an electronic device such that they may be accessible only in spaces with limited dimensions. For example, these connector receptacles may be located in openings in equipment, they may be positioned relatively close to each other, they may be close to other structures on a device, or access may be dimensionally limited for some other reason.

To be able to convey very high-frequency signals, it may be important to provide a good impedance matching along a signal path. That is, it may be desirable to avoid impedance changes, stubs, and the like along the signal path. Doing may reduce return loss, thereby improving signal quality. Conversely, errors or mismatches in impedances along a high-frequency signal path may generate reflections and insertion loss. These may degrade and corrupt a signal making reliable data transmission difficult or impossible.

Users have become accustomed to connecting devices together using cables. Plugging a phone into a charger is now a common experience. Some of these connectors provide an excellent user experience. As a result, it may be very disconcerting for a user to have a connector that is difficult to use. For this reason, it may be important to provide a connector system that provides a good user experience.

Thus, what is needed are connector systems that may be easy to use, may be used to make connections in a small area, may provide a stable and consistent connection, may provide good impedance matching, and may provide a good user experience.

### SUMMARY

Accordingly, embodiments of the present invention may provide connector systems that may be easy to use, may be used to make connections in a small area, may provide a stable and consistent connection, may provide good impedance matching, and may provide a good user experience. Various embodiments of the present invention may provide connector systems for conveying radio frequency (RF) signals.

An illustrative embodiment of the present invention may provide a connector system including a connector insert and a connector receptacle. The connector insert may include a coaxial connector having a center conductor having a central recess at a front leading edge. The coaxial connector may further include an outer barrel. The outer barrel may terminate in a tulip-shaped connector around the recessed portion of the center conductor. A housing may be formed around the coaxial connector behind the tulip-shaped contact. The housing may include one or more magnets on at least one side of the coaxial connector. In these and other embodiments of the present invention, the one or more magnets may be on at least two sides of the coaxial connector. The two sides may be opposite sides. In these and other embodiments of the present invention, the one or more magnets may be positioned concentrically around the coaxial connector. For example, one or more magnets may be positioned concentrically around the coaxial connector. The one or more magnets may have a protective layer on one or more sides. Instead of magnets, one or more ferromagnetic portions may be used in these and other configurations, or a combination of magnets and ferromagnetic pieces may be used. The center conductor and the outer barrel of the coaxial connector may terminate in conductors in a cable. The cable may be insulated. The cable may be protected with a strain relief.

The connector receptacle may include a housing supporting a ground contact. The magnet or magnets of the connector insert may be attracted to the ground contact. The ground contact may have a passage for a pin having a concentric insulating layer. The passage in the ground contact may also accept the tulip of the connector insert to provide a ground path. The pin may be inserted in the recess of the center conductor of the coaxial connector. This penetrating connection may stand in contrast to other connectors where a surface connection may be made. The pin may terminate on a board in an electronic device. The ground contact may also terminate on the board.

This connector system may be easy to use. Specifically, the magnet in the connector insert may be attracted to the ground contact in the connector receptacle. The pin of the connector receptacle may penetrate the center conductor of the coaxial connector in the connector insert without the need of turning or tightening. The magnet or magnets may fix a position to the ground contact of the connector receptacle in a consistent and stable manner. The penetration of the pin into the center conductor of the coaxial connector in the connector insert may provide a signal path having good impedance matching. The magnetic attraction of the connector insert to the connector receptacle may provide a good user experience.

In these and other embodiments of the present invention, the ground contact may be made of ferromagnetic material that may attract magnets, it may be formed of one or more magnets, or it may be a combination of these. In these and other embodiments of the present invention, the magnet or magnets of the connector insert may instead be ferromagnetic material that may be attractive to magnets in the connector receptacle, or magnets may be located in both the connector insert and the connector receptacle. In these and other embodiments of the present invention, each of the connector insert and connector receptacle may include one more magnets, one or more ferromagnetic pieces, or a combination of these.

In various embodiments of the present invention, pins, ground contacts, and other conductive portions of a connector receptacle or connector insert may be formed by stamping, metal-injection molding, machining, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions, such as the housings, insulators, or other structures may be formed using injection or other molding, 3-D printing, machining, or other manufacturing process. The nonconductive portions may be formed of silicon or silicone, rubber, hard rubber, plastic, nylon, liquid-crystal polymers (LCPs), ceramics, or other nonconductive material or combination of materials. The boards used may be formed of FR-4 or other material. The boards may be printed circuit boards or other substrates, such as flexible circuit boards, in many embodiments of the present invention. The magnets may be rare-earth or other types of magnets.

Embodiments of the present invention may provide connector receptacles and connector inserts that may be located in, and may connect to, various types of devices, such as portable computing devices, tablet computers, desktop computers, laptops, all-in-one computers, wearable computing devices, cell phones, smart phones, media phones, storage devices, portable media players, navigation systems, monitors, power supplies, video delivery systems, test systems, adapters, remote control devices, chargers, and other devices. In various embodiments of the present invention, interconnect paths provided by these connector inserts and connector receptacles may be used to convey power, ground, high-speed or other data signals, test points, and other voltage, current, data, or other information.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates a connector system according to an embodiment of the present invention;

FIG. 2 illustrates a cross-section of a connector system according to an embodiment of the present invention;

FIG. 3 illustrates a connector insert according to an embodiment of the present invention;

FIG. 4 illustrates a connector receptacle according to an embodiment of the present invention;

FIG. 5 illustrates a portion of a connector receptacle according to an embodiment of the present invention;

FIG. 6 illustrates another connector system according to an embodiment of the present invention;

FIG. 7 illustrates a cross-section of a connector system according to an embodiment of the present invention;

FIG. 8 illustrates a connector insert according to an embodiment of the present invention;

FIG. 9 illustrates a connector receptacle according to an embodiment of the present invention;

FIG. 10 illustrates a portion of a connector receptacle according to an embodiment of the present invention;

FIG. 11 illustrates a connector system according to an embodiment of the present invention;

FIG. 12 illustrates a cross-section of a connector system according to an embodiment of the present invention;

FIG. 13 illustrates a connector insert according to an embodiment of the present invention;

FIG. 14 illustrates a connector receptacle according to an embodiment of the present invention;

FIG. 15 illustrates a portion of a connector receptacle according to an embodiment of the present invention; and

FIG. 16 illustrates a portion of a connector receptacle according to an embodiment of the present invention.

### DESCRIPTION OF ILLUSTRATIVE EMBODIMENTS

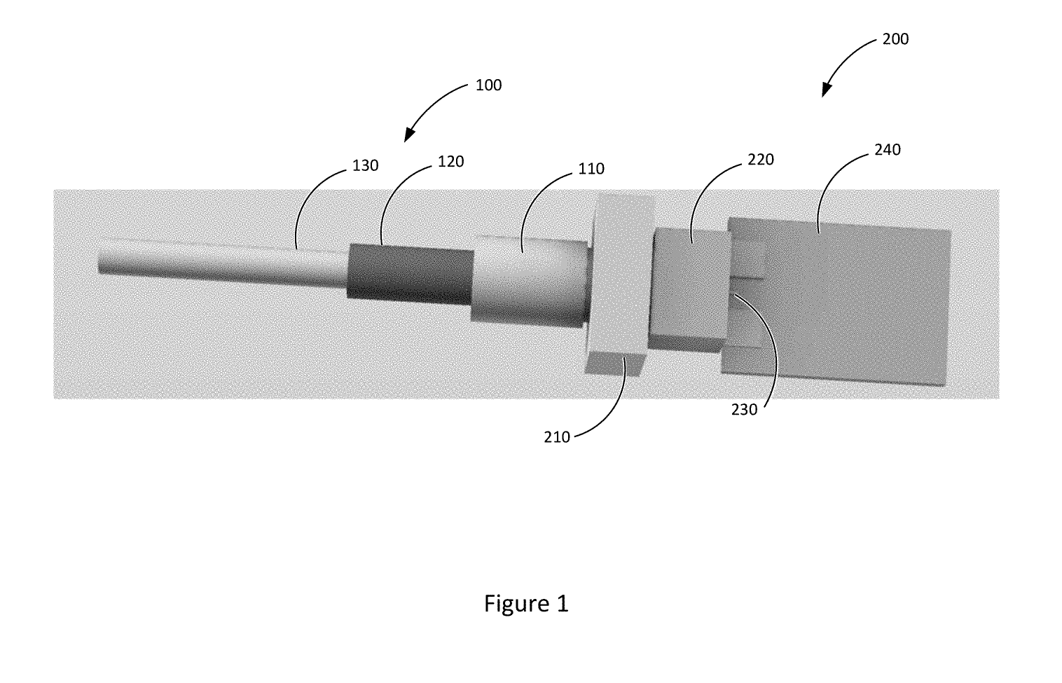

FIG. 1 illustrates a connector system according to an embodiment of the present invention. This illustrative embodiment of the present invention may provide a connector system including connector insert 100 and connector receptacle 200. This figure, as with the other included figures is shown for illustrative purposes and does not limit either the possible embodiments of the invention or the claims.

Connector insert 100 may include housing 110 and cable 130. Cable 130 may be protected by strain relief 120. Connector receptacle 200 may include housing 210, connector 220, pin 230, and board 240. More details of this connector system are shown in the following figure.

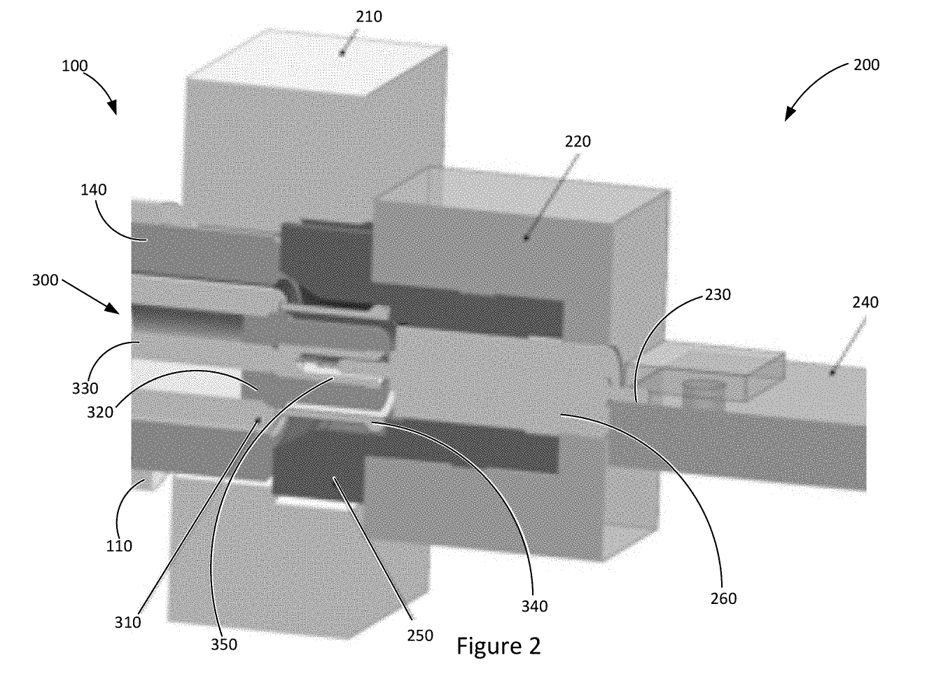

FIG. 2 illustrates a cross-section of a connector system according to an embodiment of the present invention. Connector insert 100 may include a coaxial connector 300 having a center conductor 330 having a recess 350. The coaxial connector 300 may further include an outer barrel 310. Outer barrel 310 may be positioned concentrically around center conductor 330. Outer barrel 310 may terminate in contact 340 around recess 350 of center conductor 330. Housing 110 may be formed around coaxial connector 300. Housing 110 may include one or more magnets 140 on at least one side of coaxial connector 300. In these and other embodiments of the present invention, one or more magnets 140 may be on at least two sides of coaxial connector 300. The two sides may be opposite sides. In these and other embodiments of the present invention, one or more magnets 140 may be positioned concentrically around coaxial connector 300. For example, one magnet 140 may be positioned concentrically around coaxial connector 300. Magnets 140 may have a protective layer on one or more sides. In these and other embodiments of the present invention, one or more magnets 140 may instead be ferromagnetic pieces that may be attracted to one or more magnets in the connector receptacle. Center conductor 330 of coaxial connector 300 may terminate in conductors in cable 130 (shown in FIG. 1.) Cable 130 may be insulated. Cable 130 may be protected with strain relief 120 (shown in FIG. 1.)

Connector receptacle 200 may include housing 210, which may provide a passage for a leading edge of connector insert 100. Connector receptacle 200 may include connector 220 supporting ground contact 250. The magnet or magnets 140 of connector insert 100 may be attracted to ground contact 250, which may be made of a ferromagnetic material. In these and other embodiments of the present invention, the magnet or magnets 140 of connector insert 100 may instead be ferromagnetic pieces and ground contact 250 may be, or may include, one or more magnets. Ground contact 250 may have a passage for pin 230, which may be soldered to board 240. The passage may include a concentric insulating layer or insulator 260 around a portion of pin 230. The passage in ground contact 250 may also accept contact 340 of connector insert 100 to provide a ground path. Pin 230 may be inserted in recess 350 of center conductor 330 of coaxial connector 300 when connector insert 100 and connector receptacle 200 are mated. This penetrating connection may stand in contrast to other connectors where a surface connection may be made. The pin 230 may terminate on a board 240 in an electronic device. Ground contact 250 may also terminate on board 240.

The combination of the penetrating connection between pin 230 and recess 350 of center conductor 330, along with the magnetic attraction between connector insert 100 and connector receptacle 200 may provide a stable and consistent connection with little reflection and good impedance characteristics. More specifically, magnet 140 in connector insert 100 may be attracted to ground contact 250 in connector receptacle 200. Pin 230 of connector receptacle 200 may penetrate center conductor 330 of coaxial connector 300 in connector insert 100 without the need of turning or tightening. Magnet or magnets 140 may fix a position to ground contact 250 of connector receptacle 200 in a consistent and stable manner. The penetration of pin 230 into recess 350 in center conductor 330 of coaxial connector 300 may provide a signal path having good impedance matching. The magnetic attraction of connector insert 100 to connector receptacle 200 may provide a good user experience.

In these and other embodiments of the present invention, ground contact 250 may be formed of a ferromagnetic material that may attract magnets 140, it may be formed of one or more magnets, or it may be a combination of these. In these and other embodiments of the present invention, the magnet or magnets 140 of connector insert 100 may instead be ferromagnetic pieces that are attractive to magnets in connector receptacle 200, or magnets 140 may be located in both connector insert 100 and connector receptacle 200.

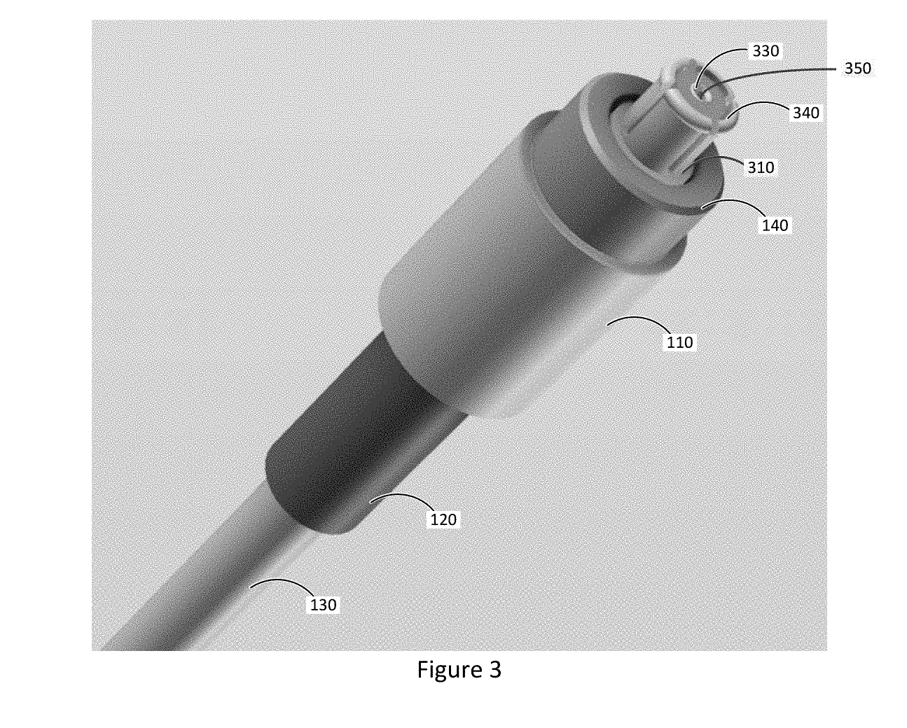

FIG. 3 illustrates a connector insert according to an embodiment of the present invention. Center conductor 330 may include central recess 350 and may be surrounded by contact 340 of outer barrel 310 of coaxial connector 300 (shown in FIG. 2.) Housing 110 may be around magnet 140. Magnet 140 may be protected with a coating or other layer. Connector insert 100 and connector receptacle 200 may be arranged to provide a protective spacing between them for magnet 140. Cable 130 may be protected by strain relief 120.

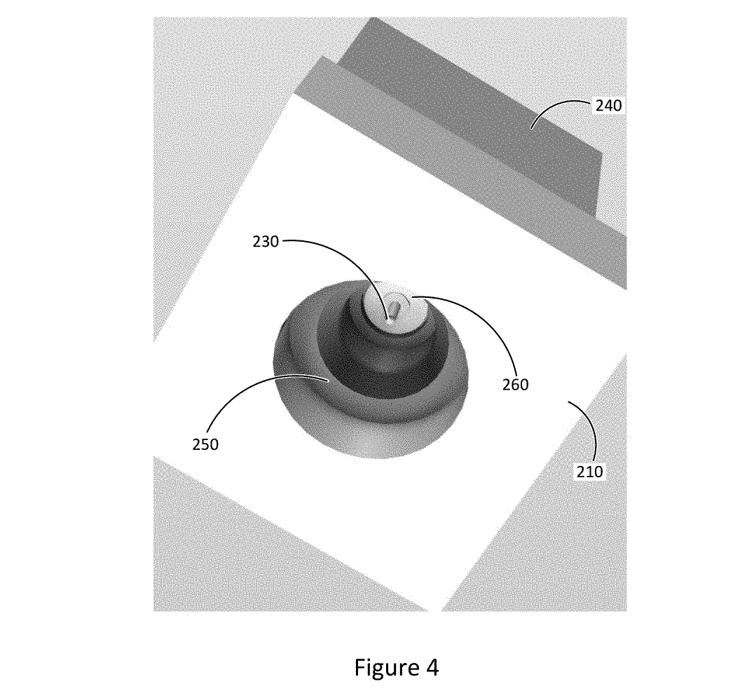

FIG. 4 illustrates a connector receptacle according to an embodiment of the present invention. Housing 210 may provide access to ground contact 250. Ground contact 250 may have an opening for pin 230 and insulator 26. Pin 230 may attached to board 240.

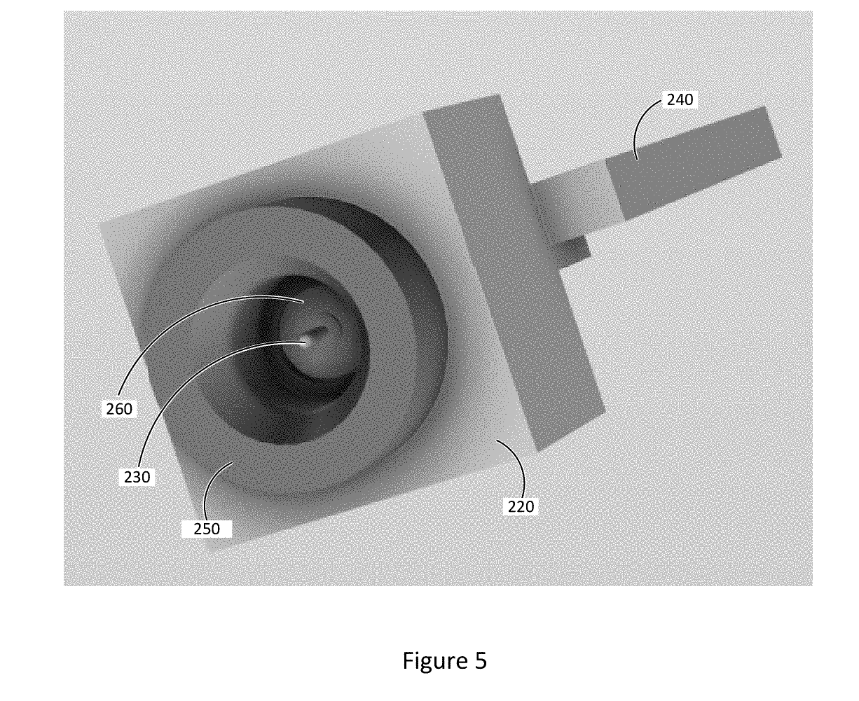

FIG. 5 illustrates a portion of a connector receptacle according to an embodiment of the present invention. In this example housing 210 has been removed to show connector 220, ground contact 250, pin 230, and insulator 260. Pin 230 may attached to board 240.

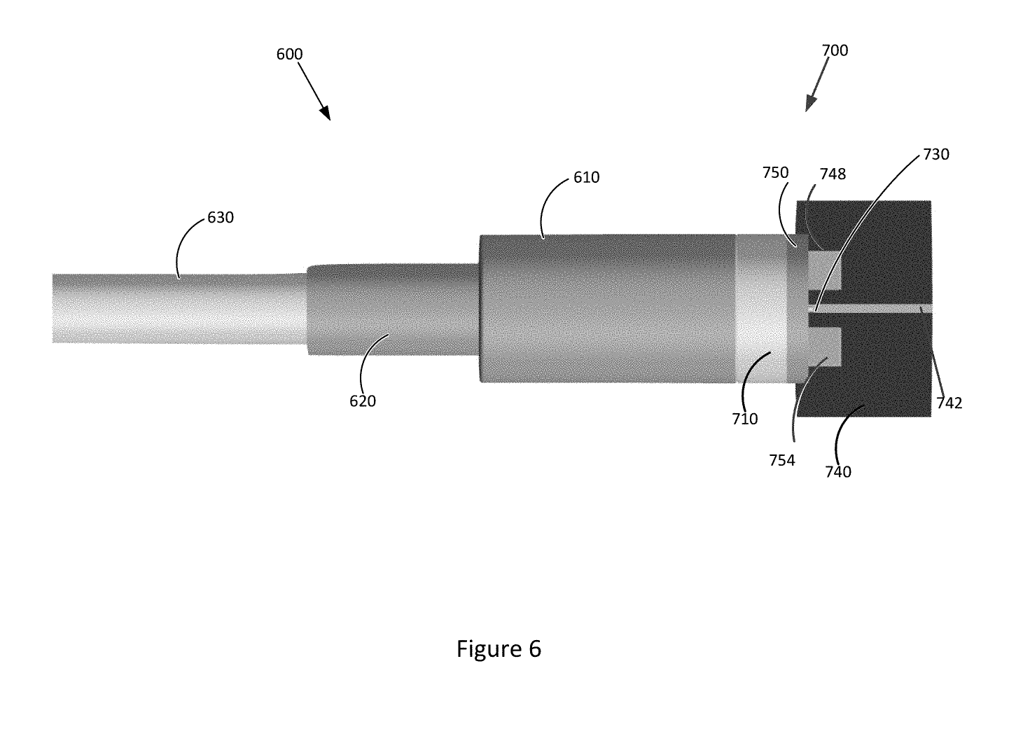

FIG. 6 illustrates a connector system according to an embodiment of the present invention. This illustrative embodiment of the present invention may provide a connector system including connector insert 600 and connector receptacle 700. Connector insert 600 and connector receptacle 700 may be substantially similar to connector insert 100 and connector receptacle 200 in the above examples, with various modifications, some of which are described below.

Connector insert 600 may include housing 610 and cable 630. Cable 630 may be protected by strain relief 620. Connector receptacle 700 may include magnetic target 710, pin 730, board 740, and ground contact 750. Pin 730 may connect to trace 742 on board 740. Ground contact 750 may include tabs 754, which may electrically connect to ground traces or planes 748 on board 740. More details of this connector system are shown in the following figure.

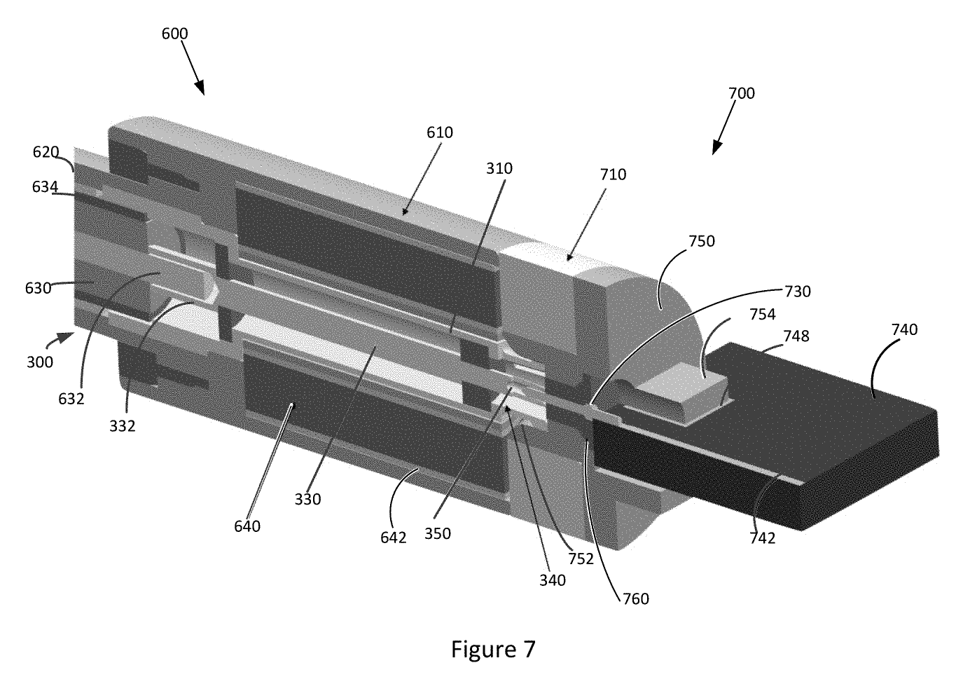

FIG. 7 illustrates a cross-section of a connector system according to an embodiment of the present invention. Connector insert 600 may include a coaxial connector 300 having a center conductor 330 with a recess 350. The coaxial connector 300 may further include an outer barrel 310 positioned concentrically around the center conductor. Outer barrel 310 may terminate in tulip-shaped contact 340 around recess 350 in center conductor 330. Housing 610 may be formed concentrically around coaxial connector 300. Housing 610 may include one or more magnets 640 on at least one side of coaxial connector 300. In these and other embodiments of the present invention, one or more magnets 640 may be on at least two sides of coaxial connector 300. The two sides may be opposite sides. In these and other embodiments of the present invention, one or more magnets 640 may be positioned concentrically around coaxial connector 300. For example, one magnet 640 may be positioned concentrically around coaxial connector 300. The magnet 640 may have a first polarity (either North or South) at a leading edge of connector insert 600 and a second polarity at a trailing edge of connector insert 600. In these and other embodiments of the present invention, two magnets 640 may be used and they may be arranged to have opposing polarities. Magnet or magnets 640 may have a protective layer 642 on one or more sides—between the magnet 640 and housing 610, between the magnet 640 and coaxial connector 300, or both. In these and other embodiments of the present invention, one or more magnets 640 may instead be ferromagnetic pieces that may be attracted to one or more magnets in the connector receptacle. Outer barrel 310 and center conductor 330 of coaxial connector 300 may terminate in conductors in cable 630. Specifically, a trailing edge of center conductor 330 may include recess 332. Signal conductor 632 in cable 630 may inserted into recess 332 and soldered, crimped, or otherwise attached. Ground shield 634 of cable 630 may electrically connect to outer barrel 310 at a trailing edge of outer barrel 310. Cable 630 may be insulated. Cable 630 may be protected by strain relief 620.

In this example, a signal path may include conductor 632 and center conductor 330 in connector insert 600 and pin 730 and trace 742 in connector receptacle 700. A ground path may include shield 634 and outer barrel 310 in connector insert 600 and ground contact 750 in connector receptacle 700.

Connector receptacle 700 may include magnetic target 710 supported by ground contact 750. The magnet or magnets 640 of connector insert 600 may be attracted to magnetic target 710, which may be made of a ferromagnetic material. In these and other embodiments of the present invention, the magnet or magnets 640 of connector insert 600 may instead be ferromagnetic pieces and magnetic target 710 may be, or may include, one or more magnets. Ground contact 750 may include tabs 754. Tabs 754 may be soldered, glued, or otherwise in contact with or attached to board 740. Ground contact 750 may have a passage for pin 730. The passage may include a concentric insulator 760 around a portion of pin 730. The passage in ground contact 750 may also accept contact 340 of connector insert 600 to provide a ground path. A front opening of the passage formed by ground contact 750 may include taper 752. Taper 752 may guide contact 340 into the passage during mating of connector insert 600 and connector receptacle 700. This may simplify the insertion process and improve the overall user experience.

Pin 730 may be inserted in recess 350 of center conductor 330 of coaxial connector 300 when connector insert 600 and connector receptacle 700 are mated. This penetrating connection may stand in contrast to other connectors where a surface connection may be made. The pin 730 may terminate on a board 740 in an electronic device. Ground contact 750 may also terminate on board 740.

The combination of the penetrating connection between pin 730 and recess 350 of center conductor 330, along with the magnetic attraction between connector insert 600 and connector receptacle 700, may provide a stable and consistent connection with little reflection and good impedance characteristics. More specifically, magnet 640 in connector insert 100 may be attracted to magnetic target 710 in connector receptacle 200. Pin 730 of connector receptacle 200 may penetrate center conductor 330 of coaxial connector 300 in connector insert 600 without the need of turning or tightening. Magnet or magnets 640 may fix a position to magnetic target 710 of connector receptacle 700 in a consistent and stable manner. The penetration of pin 730 into recess 350 in center conductor 330 of coaxial connector 300 may provide a signal path having good impedance matching. The magnetic attraction of connector insert 600 to connector receptacle 700 may provide a good user experience.

In these and other embodiments of the present invention, magnetic target 710 may be formed of a ferromagnetic material that may attract magnets 640, it may be formed of one or more magnets, or it may be a combination of these. In these and other embodiments of the present invention, the magnet or magnets 640 of connector insert 600 may instead be ferromagnetic pieces that are attractive to magnets in connector receptacle 700, or magnets may be located in both connector insert 600 and connector receptacle 700.

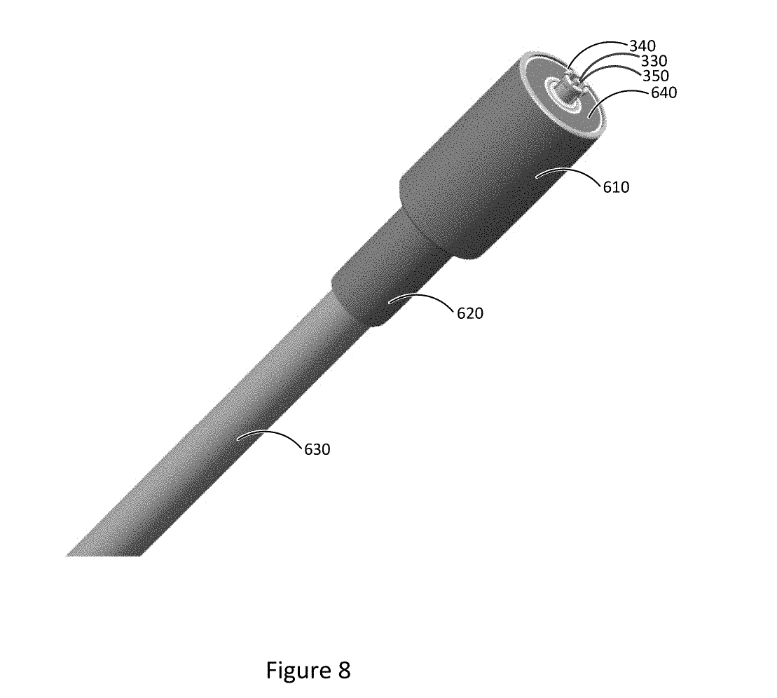

FIG. 8 illustrates a connector insert according to an embodiment of the present invention. Center conductor 330 may include central recess 350 and may be surrounded by tulip-shaped contact 340. Housing 610 may be around magnet 640. Magnet 640 may be protected with a coating or other layer. Connector insert 600 and connector receptacle 700 may be arranged to provide a protective spacing between them for magnet 640. Cable 630 may be protected by strain relief 620.

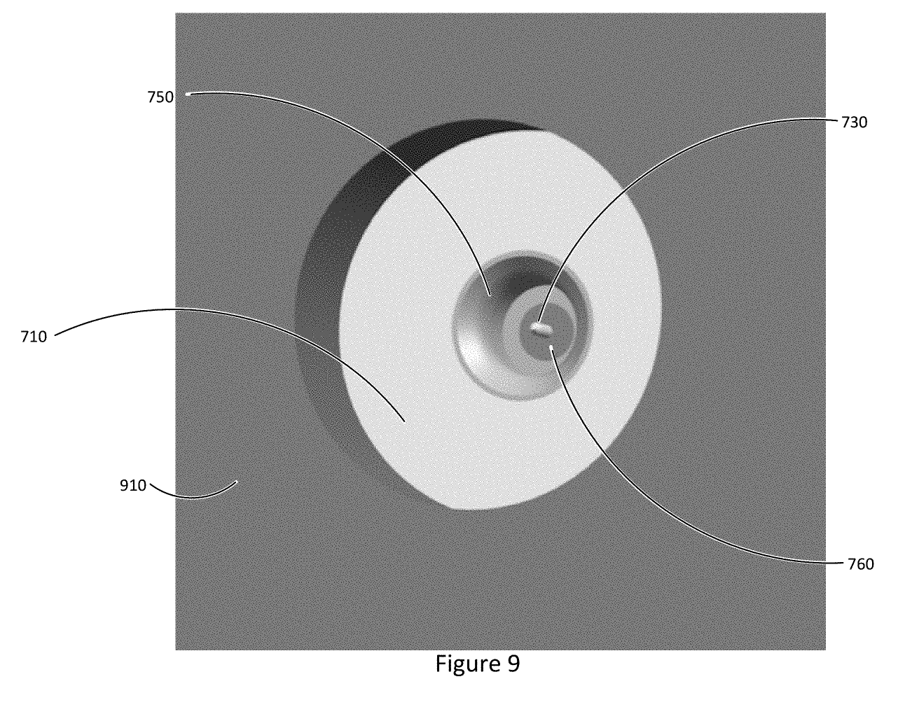

FIG. 9 illustrates a connector receptacle according to an embodiment of the present invention. An additional housing 910 may provide access to magnetic target 710, which may have an opening for ground contact 750, pin 730, and insulator 760.

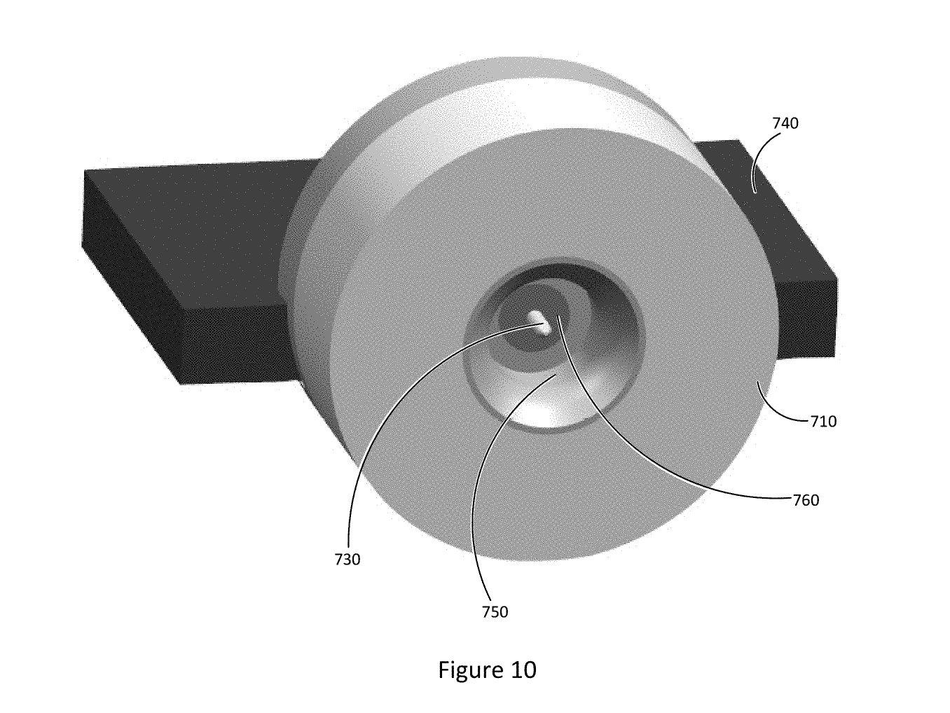

FIG. 10 illustrates a portion of a connector receptacle according to an embodiment of the present invention. In this example, additional housing 910 has been removed to show magnetic target 710, ground contact 750, pin 730, and insulator 760. Pin 730 may connect to trace 742 (shown in FIG. 7) on board 740.

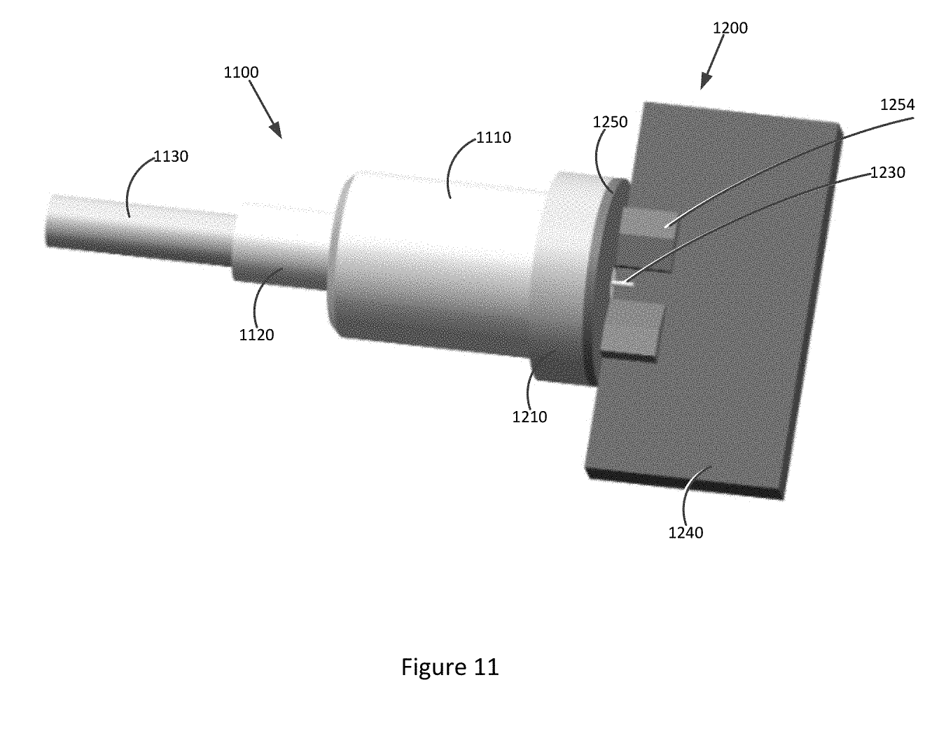

FIG. 11 illustrates a connector system according to an embodiment of the present invention. This illustrative embodiment of the present invention may provide a connector system including connector insert 1100 and connector receptacle 1200. Connector insert 1100 and connector receptacle 1200 may be substantially similar to connector inserts 100 and 600 and connector receptacles 200 and 700 in the above examples, with various modifications, some of which are described below.

Connector insert 1100 may include housing 1110 and cable 1130. Cable 1130 may be protected by strain relief 1120. Connector receptacle 1200 may include magnetic target 1210, pin 1230, board 1240, and ground contact 1250. Pin 1230 may connect to a trace (not shown) on board 1240. Ground contact 1250 may include tabs 1254, which may electrically connect to ground traces or planes (not shown) on board 1240. In these and other embodiments of the present invention, magnetic target 1210 may have a larger radius than connector insert housing 1110. This may help users to attach connector insert 1100 to magnetic target 1210 and improve the user experience. More details of this connector system are shown in the following figure.

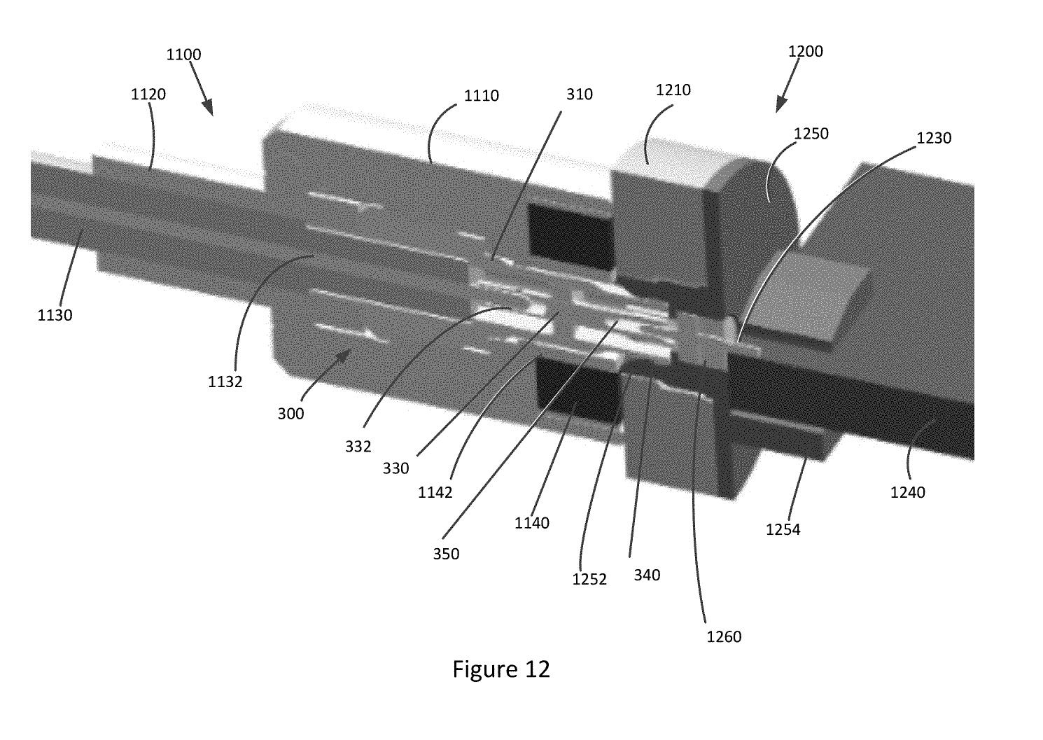

FIG. 12 illustrates a cross-section of a connector system according to an embodiment of the present invention. Connector insert 1100 may include a coaxial connector 300 having a center conductor 330 with a recess 350. The coaxial connector 300 may further include an outer barrel 310 positioned concentrically around the center conductor. Outer barrel 310 may terminate in tulip-shaped contact 340 around recess 350 in center conductor 330. Housing 1110 may be formed concentrically around coaxial connector 300. Housing 1110 may include one or more magnets 1140 on at least one side of coaxial connector 300. Relative to magnets 640 in connector insert 600 (shown in FIG. 7), magnets 1140 may have a shorter length and be located around a front of coaxial connector 300. This may help to reduce a diameter of connector insert 1100. This reduction may allow the relative diameter of magnetic target 1210 to be larger, thereby improving a user experience. In these and other embodiments of the present invention, one or more magnets 1140 may be on at least two sides of coaxial connector 300. The two sides may be opposite sides. In these and other embodiments of the present invention, one or more magnets 1140 may be positioned concentrically around coaxial connector 300. For example, one magnet 1140 may be positioned concentrically around coaxial connector 300. The magnet 1140 may have a first polarity (either North or South) at a leading edge of connector insert 1100 and a second polarity at a trailing edge of connector insert 1100. In these and other embodiments of the present invention, two magnets 1140 may be used and they may be arranged to have opposing polarities. Magnet or magnets 1140 may have a protective layer 1142 on one or more sides—between the magnet 1140 and housing 1110, between the magnet 1140 and coaxial connector 300, or both. In these and other embodiments of the present invention, one or more magnets 1140 may instead be ferromagnetic pieces that may be attracted to one or more magnets in the connector receptacle. Outer barrel 310 and center conductor 330 of coaxial connector 300 may terminate in conductors in cable 1130. Specifically, a trailing edge of center conductor 330 may include recess 332. Signal conductor 1132 in cable 1130 may inserted into recess 332 and soldered, crimped, or otherwise attached. A ground shield (not shown) of cable 1130 may electrically connect to outer barrel 310 at a trailing edge of outer barrel 310. Cable 1130 may be insulated. Cable 1130 may be protected by strain relief 1120.

In this example, a signal path may include conductor 1132 and center conductor 330 in connector insert 1100 and pin 1230 and a trace (not shown) on board 1240 in connector receptacle 1200. A ground path may include a shield (not shown) around cable 1130 and outer barrel 310 in connector insert 1100, as well as ground contact 1250, ground contact tabs 1254, and ground paths (not shown) on board 1240 in connector receptacle 1200.

Connector receptacle 1200 may include magnetic target 1210 supported by ground contact 1250. The magnet or magnets 1140 of connector insert 1100 may be attracted to magnetic target 1210, which may be made of a ferromagnetic material. In these and other embodiments of the present invention, the magnet or magnets 1140 of connector insert 1100 may instead be ferromagnetic pieces and magnetic target 1210 may be, or may include, one or more magnets. Ground contact 1250 may include tabs 1254. Tabs 1254 may be soldered, glued, or otherwise in contact with or attached to board 1240. Ground contact 1250 may have a passage for pin 1230. The passage may include a concentric insulator 1260 around a portion of pin 1230. The passage in ground contact 1250 may also accept contact 340 of connector insert 1100 to provide a ground path. A front opening of the passage formed by ground contact 1250 may include taper 1252. Taper 1252 may guide contact 340 into the passage during mating of connector insert 1100 and connector receptacle 1200. This may simplify the insertion process to help reduce damage to contact 340 and improve the overall user experience.

Pin 1230 may be inserted in recess 350 of center conductor 330 of coaxial connector 300 when connector insert 1100 and connector receptacle 1200 are mated. This penetrating connection may stand in contrast to other connectors where a surface connection may be made. The pin 1230 may terminate on a board 1240 in an electronic device. Ground contact 1250 may also terminate on board 1240 at tabs 1254. Tabs 1254 may be connected to ground traces or planes (not shown) on board 1240.

The combination of the penetrating connection between pin 1230 and recess 350 of center conductor 330, along with the magnetic attraction between connector insert 1100 and connector receptacle 1200, may provide a stable and consistent connection with little reflection and good impedance characteristics. More specifically, magnet 1140 in connector insert 100 may be attracted to magnetic target 1210 in connector receptacle 200. Pin 1230 of connector receptacle 200 may penetrate center conductor 330 of coaxial connector 300 in connector insert 1100 without the need of turning or tightening. Magnet or magnets 1140 may fix a position to magnetic target 1210 of connector receptacle 1200 in a consistent and stable manner. The penetration of pin 1230 into recess 350 in center conductor 330 of coaxial connector 300 may provide a signal path having good impedance matching. The magnetic attraction of connector insert 1100 to connector receptacle 1200 may provide a good user experience and a stable connection.

In these and other embodiments of the present invention, magnetic target 1210 may be formed of a ferromagnetic material that may attract magnets 1140, it may be formed of one or more magnets, or it may be a combination of these. In these and other embodiments of the present invention, the magnet or magnets 1140 of connector insert 1100 may instead be ferromagnetic pieces that are attractive to magnets in connector receptacle 1200, or magnets may be located in both connector insert 1100 and connector receptacle 1200.

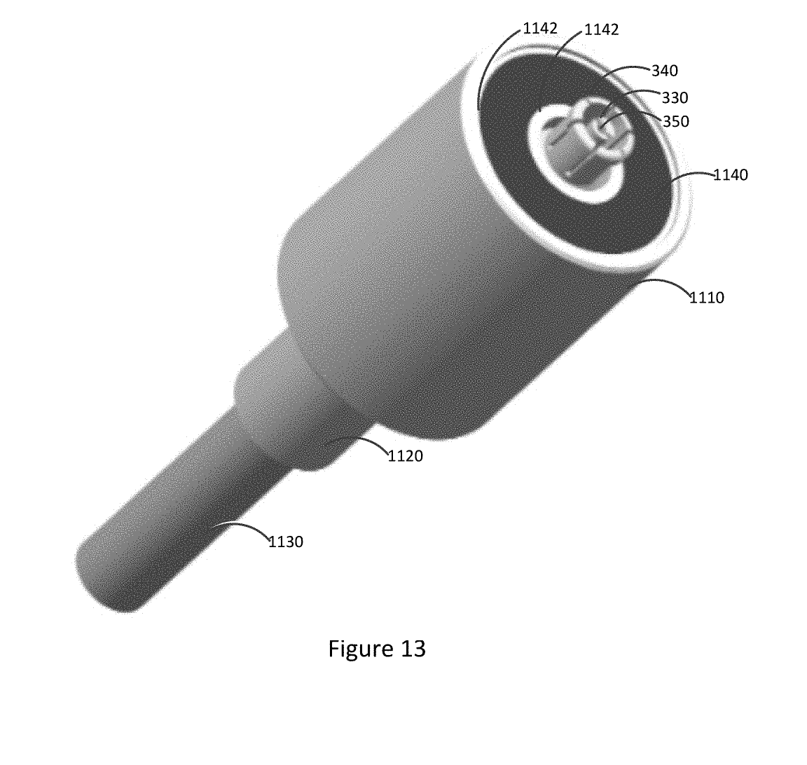

FIG. 13 illustrates a connector insert according to an embodiment of the present invention. Center conductor 330 may include central recess 350 and may be surrounded by tulip-shaped contact 340. Housing 1110 may be around magnet 1140. Magnet 1140 may be protected with coatings or other layers 1142. Connector insert 1100 and connector receptacle 1200 may be arranged to provide a protective spacing between them for magnet 1140. Cable 1130 may be protected by strain relief 1120.

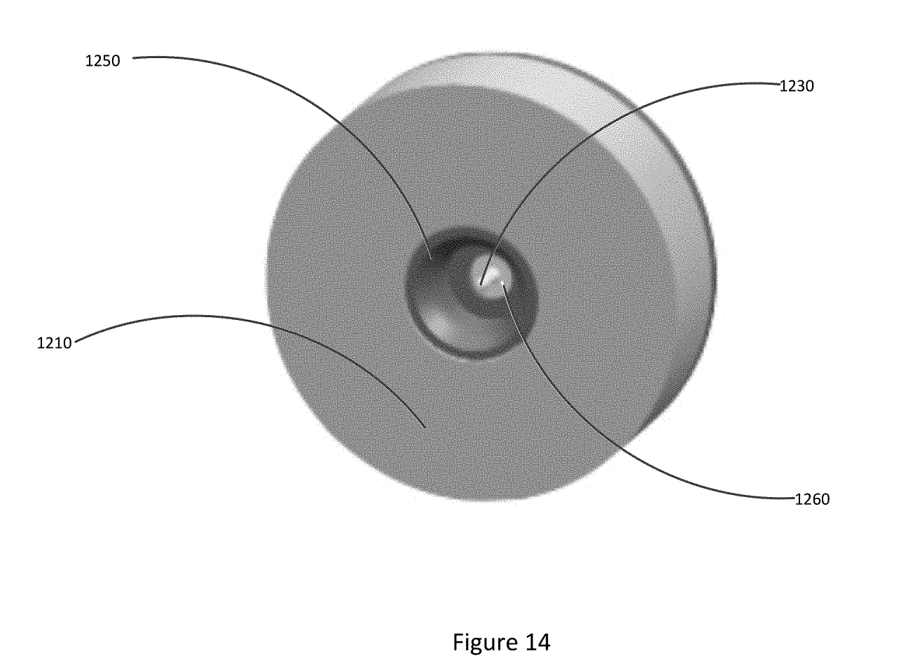

FIG. 14 illustrates a connector receptacle according to an embodiment of the present invention. Magnetic target 1210 may have an opening for ground contact 1250, pin 1230, and insulator 1260.

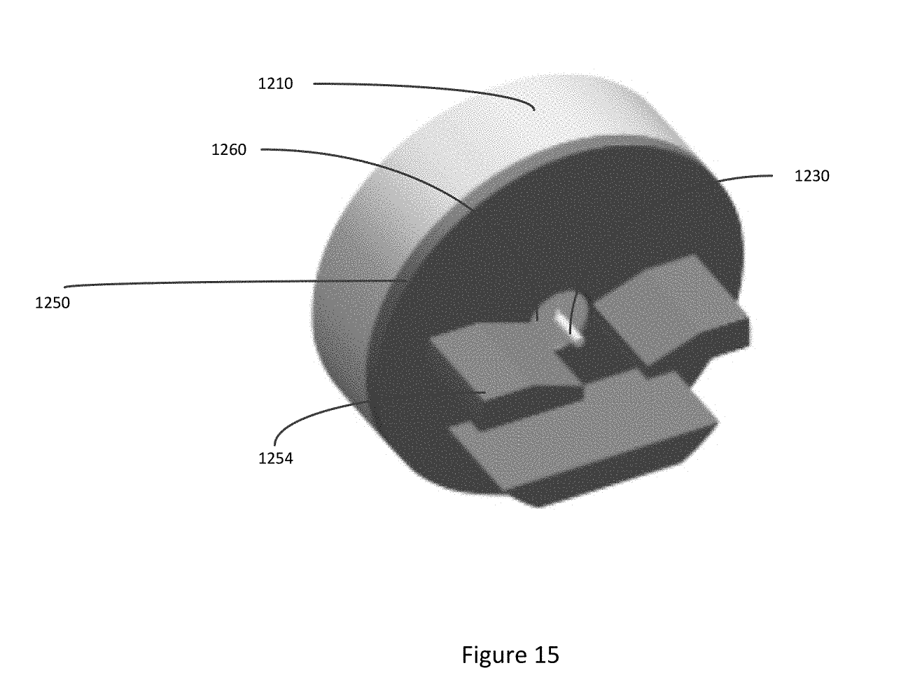

FIG. 15 illustrates a portion of a connector receptacle according to an embodiment of the present invention. Magnetic target 1210 may be supported by ground contact 1250. Pin 1230 may be surrounded by insulator 1260 and may pass through magnetic target 1210 and ground contact 1250. Tabs 1254 may extend from a rear of ground contact 1250. Pin 1230 and tabs 1254 may be connected to traces or planes on board 1240 (shown in FIG. 12.) An example is shown in the following figure.

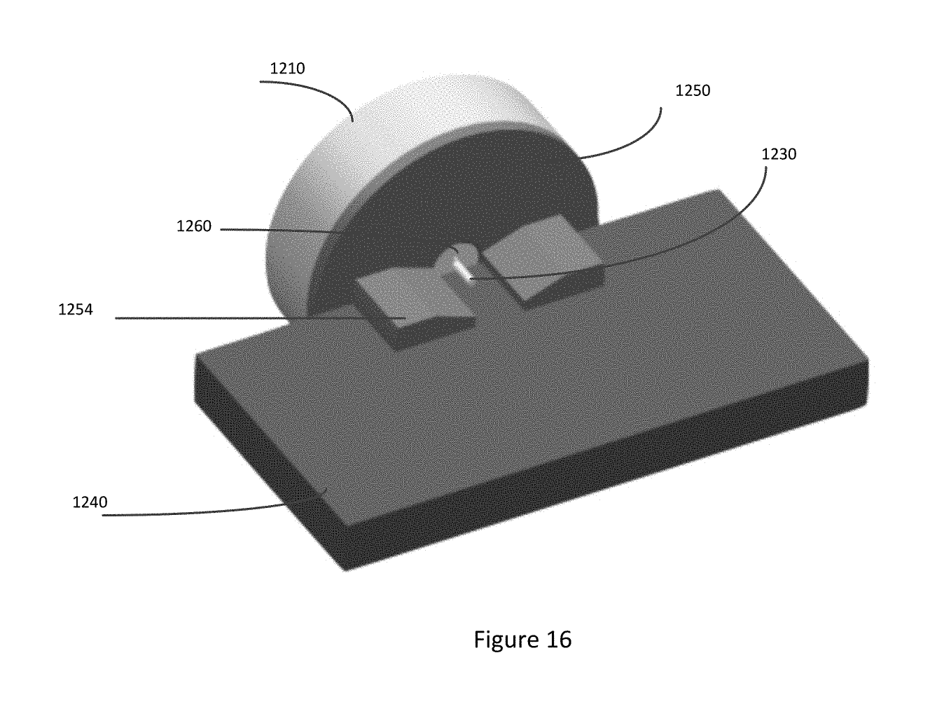

FIG. 16 illustrates a portion of a connector receptacle according to an embodiment of the present invention. Magnetic target 1210 may be supported by ground contact 1250. Pin 1230 may be surrounded by insulator 1260 and may pass through magnetic target 1210 and ground contact 1250. Tabs 1254 may extend from a rear of ground contact 1250. Pin 1230 may be connected to a signal trace (not shown) board 1240. Tabs 1254 may be soldered, glued, or otherwise attached or in contact with board 1240. Tabs 1254 may be in electrical contact with planes or traces (not shown), for example a ground plane, on board 1240.

Various structures may be used as the coaxial connector 300 and other coaxial connectors that may be included in connectors inserts according to embodiments of the present invention. These coaxial connectors may be purchased from a vendor or their construction may be included as part of the construction of connectors inserts according to embodiments of the present invention. For example, these coaxial connectors may be manufactured for example, by Corning Gilbert of Glendale, Ariz., a wholly owned subsidiary of Corning Incorporated, of Corning N.Y., as one of their GPPO Cable Connectors, or by Carlisle Interconnect Technologies of Cerritos, Calif., as one of their SSMP connectors.

In various embodiments of the present invention, pins, ground contacts, and other conductive portions of a connector receptacle or connector insert may be formed by stamping, metal-injection molding, machining, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions, such as the housings, insulators, or other structures may be formed using injection or other molding, 3-D printing, machining, or other manufacturing process. The nonconductive portions may be formed of silicon or silicone, rubber, hard rubber, plastic, nylon, liquid-crystal polymers (LCPs), ceramics, or other nonconductive material or combination of materials. The boards used may be formed of FR-4 or other material. The boards may be printed circuit boards or other substrates, such as flexible circuit boards, in many embodiments of the present invention. The magnets may be rare-earth or other types of magnets. The ferromagnetic materials may be ferrimagnetic or other type of magnetically conductive material.

Embodiments of the present invention may provide connector receptacles and connector inserts that may be located in, and may connect to, various types of devices, such as portable computing devices, tablet computers, desktop computers, laptops, all-in-one computers, wearable computing devices, cell phones, smart phones, media phones, storage devices, portable media players, navigation systems, monitors, power supplies, video delivery systems, test systems, adapters, remote control devices, chargers, and other devices. In various embodiments of the present invention, interconnect paths provided by these connector inserts and connector receptacles may be used to convey power, ground, signals, test points, and other voltage, current, data, or other information.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A magnetic radio frequency (RF) connector system comprising:
a connector insert comprising:
a coaxial connector having barrel positioned concentrically around a center conductor, the barrel terminating in a contact;
a magnet positioned concentrically around the coaxial connector; and
a cable having a conductor coupled to the center conductor of the coaxial connector; and
a connector receptacle comprising:
a pin to electrically connect to the center conductor when the connector insert and the connector receptacle are mated;
an insulating layer positioned concentrically around the pin;
a ground contact positioned concentrically around the insulating layer and having a center passage to accept the contact of the connector insert when mated, wherein the pin and the insulating layer are located in the center passage; and
a magnetic target positioned concentrically around the pin.

2. The connector system of claim 1 wherein the contact is a tulip-shaped contact.

3. The connector system of claim 2 wherein the center conductor comprises a recess at a leading edge of the center conductor, the recess to accept the pin when the connector insert and the connector receptacle are mated.

4. The connector system of claim 3 wherein the connector insert further comprises a housing formed around the magnet.

5. The connector system of claim 4 wherein the connector insert further comprises a protective layer between the housing and the magnet.

6. The connector system of claim 5 further wherein a trailing edge of the center conductor includes a second recess, and wherein the conductor of the cable is located in the second recess.

7. The connector system of claim 6 wherein a trailing edge of the barrel is electrically connected to a shield of the cable.

8. A magnetic radio frequency (RF) connector insert comprising:
a coaxial connector having barrel positioned concentrically around a center conductor, the barrel terminating in a contact;
a magnet positioned concentrically around the coaxial connector; and
a cable having a conductor coupled to the center conductor of the coaxial connector and a shield coupled to the barrel.

9. The connector insert of claim 8 wherein a leading edge of the barrel terminates in a tulip-shaped contact.

10. The connector insert of claim 9 wherein the center conductor comprises a recess at a leading edge of the center conductor.

11. The connector insert of claim 10 wherein the connector insert further comprises a housing formed around the magnet.

12. The connector insert of claim 11 wherein the connector insert further comprises a protective layer between the housing and the magnet.

13. The connector insert of claim 12 wherein a trailing edge of the center conductor includes a second recess, and wherein the conductor of the cable is located in the second recess.

14. The connector insert of claim 13 wherein a trailing edge of the barrel is electrically connected to a shield of the cable.

15. The connector insert of claim 14 further comprising a strain relief around a portion of the cable behind the housing.

16. A magnetic radio frequency (RF) connector receptacle comprising:
a pin;
an insulating layer positioned concentrically around the pin;
a ground contact positioned concentrically around the insulating layer and having a center passage to accept a contact of a connector insert, wherein the pin and the insulating layer are located in the center passage; and
a magnetic target positioned concentrically around the pin.

17. The connector receptacle of claim 16 further comprising a board to support the pin.

18. The connector receptacle of claim 17 wherein the ground contact is attached to the board.

19. The connector receptacle of claim 18 wherein the magnetic target is formed of a ferromagnetic material.

20. The connector receptacle of claim 19 wherein a front opening of center passage is tapered to allow an insertion of the connector insert contact.
